(19) United States
(12) Patent Application Publication
(10) Pub. No.: US 2014/0049824 A1
(43) Pub. Date: Feb. 20, 2014

(54) IMAGING APPARATUS

(71) Applicant: PANASONIC CORPORATION, Osaka (JP)

(72) Inventors: Norikazu KATSUYAMA, Osaka (JP); Hironori HONSHO, Hyogo (JP)

(73) Assignee: PANASONIC CORPORATION, Osaka (JP)

(21) Appl. No.: 14/061,588

(22) Filed: Oct. 23, 2013

Related U.S. Application Data
(63) Continuation of application No. PCT/JP2012/008369, filed on Dec. 27, 2012.

(30) Foreign Application Priority Data
Dec. 28, 2011 (JP) 2011-288482

(51) Int. Cl. G02B 27/00

(52) U.S. Cl. CPC G02B 27/0006
USPC 359/509

(57) ABSTRACT

An imaging apparatus (100) includes an outer shell (1) having a spherical inner surface, a camera body (2) configured to be movable inside the outer shell (1) and to shoot an image of an object outside the outer shell (1) through the outer shell (1), first to third drivers (26A-26C) attached to the camera body (2) and configured to drive the camera body (2) with the first to third drivers (26A-26C) contacting an inner surface of the outer shell (1), and a cleaner (7) configured to clean up a foreign substance on the inner surface of the outer shell (1).

### CROSS-REFERENCE TO RELATED APPLICATIONS

This is a continuation of International Application No. PCT/JP2012/008369 filed on Dec. 27, 2012, which claims priority to Japanese Patent Application No. 2011-288482 filed on Dec. 28, 2011. The entire disclosures of these applications are incorporated by reference herein.

### BACKGROUND

The technique disclosed herein relates to an imaging apparatus including an imager arranged inside a case.

In an imaging apparatus described in Japanese Patent Publication No. H09-254838, an imager is arranged inside a spherical shell (case) having an inner spherical zone surface. In the imaging apparatus, the imager moves relative to the inner surface of the spherical shell. This allows shooting while adjusting an imaging range. More specifically, the imager includes three drive wheels, and the drive wheels contact the inner surface of the spherical shell. In such a manner that the drive wheels are driven, the imager moves along the inner surface of the spherical shell. The imager shoots, through the spherical shell, an image of an object outside the spherical shell.

### SUMMARY

However, in the imaging apparatus described in Japanese Patent Publication No. H09-254838, the imager moves in contact with the inner surface of the spherical shell, and therefore abrasion powder is generated inside the spherical shell. Since the imager shoots, through the spherical shell, an image of an object outside the spherical shell, there is a possibility that, if there is abrasion powder in the spherical shell, the abrasion powder unexpectedly appears in a shot image.

The technique disclosed herein has been made in view of the foregoing, and is directed to reduce degradation of an image quality due to a foreign substance(s) inside a case.

The technique disclosed herein is intended for an imaging apparatus for shooting an image of an object. The imaging apparatus includes a case having a spherical inner surface; an imager configured to be movable inside the case and to shoot the image of the object outside the case through the case; a driver attached to the imager and configured to drive the imager with the driver contacting an inner surface of the case; and a cleaner configured to clean up a foreign substance on the inner surface of the case.

According to the technique disclosed herein, degradation of the image quality due to a foreign substance(s) inside the case can be reduced.

### BRIEF DESCRIPTION OF THE DRAWINGS

FIG. 1 is a perspective view of an imaging apparatus of a first embodiment.

FIGS. 2A and 2B are cross-sectional views of the imaging apparatus. FIG. 2A is the cross-sectional view of the imaging apparatus along a plane passing through the center of an outer shell and being perpendicular to a P axis. FIG. 2B is the cross-sectional view of the imaging apparatus along a B-B line illustrated in FIG. 2A.

FIGS. 3A and 3B illustrate a camera body. FIG. 3A is a perspective view of the camera body. FIG. 3B is a front view of the camera body.

FIG. 4 is an exploded perspective view of a movable frame and first to third drivers.

FIG. 5 is a functional block diagram of the imaging apparatus.

FIG. 6 is a perspective view of a cleaner.

FIG. 7 is a flowchart of a drive control.

FIG. 8 is a view illustrating a usage example of the imaging apparatus.

FIG. 9 is a perspective view of an imaging apparatus of a second embodiment.

FIGS. 10A and 10B are cross-sectional views of the imaging apparatus. FIG. 10A is the cross-sectional view of the imaging apparatus along a plane passing through the center of an outer shell and including a P axis. FIG. 10B is the cross-sectional view of the imaging apparatus along a B-B line illustrated in FIG. 10A.

FIGS. 11A, 11B, and 11C illustrate a camera body. FIG. 11A is a perspective view of the camera body. FIG. 11B is a right side view of the camera body. FIG. 11C is a perspective view of the camera body from an angle different from that of FIG. 11A.

FIG. 12 is an exploded perspective view of a movable frame and first to third drivers.

FIG. 13 is a flowchart of a drive control.

### DETAILED DESCRIPTION

Embodiments are described in detail below with reference to the attached drawings. However, unnecessarily detailed description may be omitted. For example, detailed description of well known techniques or description of the substantially same elements may be omitted. Such omission is intended to prevent the following description from being unnecessarily redundant and to help those skilled in the art easily understand it.

Inventor(s) provides the following description and the attached drawings to enable those skilled in the art to fully understand the present disclosure. Thus, the description and the drawings are not intended to limit the scope of the subject matter defined in the claims.

### First Embodiment

<1. Schematic Configuration>

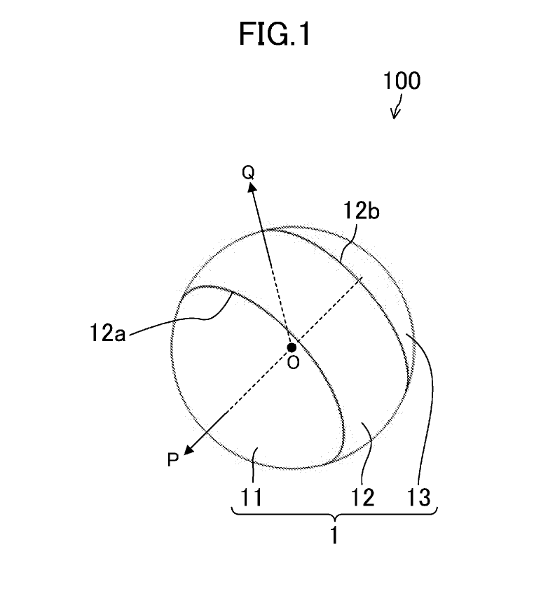

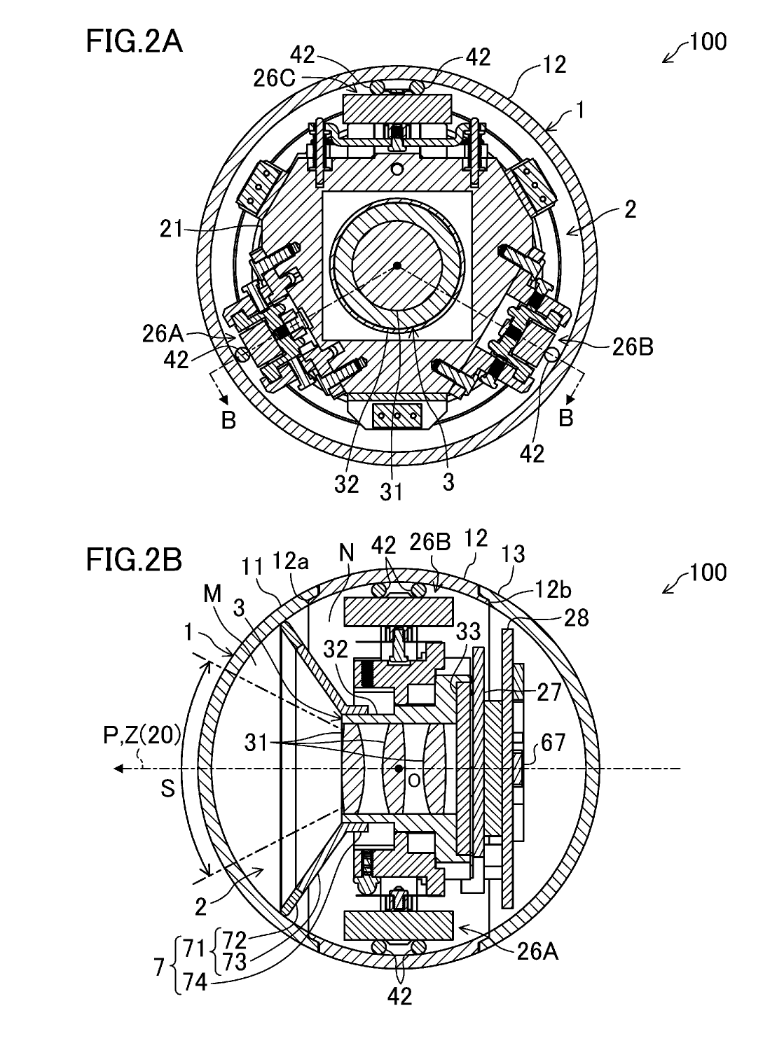

FIG. 1 is a perspective view of an imaging apparatus 100. FIGS. 2A and 2B are cross-sectional views of the imaging apparatus 100. FIG. 2A is the cross-sectional view of the imaging apparatus 100 along a plane passing through the center O of an outer shell 1 and being perpendicular to a P axis, and FIG. 2B is the cross-sectional view of the imaging apparatus 100 along a B-B line illustrated in FIG. 2A.

The imaging apparatus 100 includes the substantially spherical outer shell 1, a camera body 2 arranged inside the outer shell 1, and a cleaner 7 configured to clean up a foreign substance(s) inside the outer shell 1. The camera body 2 moves relative to the outer shell 1 along an inner surface of the outer shell 1. While moving inside the outer shell 1, the camera body 2 shoots, through the outer shell 1, an image of an object outside the outer shell 1.

<2. Outer Shell>

The outer shell 1 includes a first case 11, a second case 12, and a third case 13. The first case 11 and the second case 12 are joined together, and the second case 12 and the third case 13 are joined together. The entirety of the outer shell 1 is in a substantially spherical shape. The outer shell 1 has a substantially spherical inner surface.

The first case 11 is formed in a spherical-sector shape so as not to have the great circle of the outer shell 1. An inner surface of the first case 11 is formed in a spherical-sector shape. The first case 11 is made of acrylic resin transparent to visible light. The light transmittance of the first case 11 is higher than those of the second case 12 and the third case 13. The “spherical sector” means a “spherical zone” formed with only one opening.

The second case 12 is formed in a spherical-zone shape so as to have the great circle of the outer shell 1, and the second case 12 is formed with two openings 12a, 12b. The openings 12a, 12b each form a small circle of the outer shell 1, and are parallel to the great circle of the outer shell 1. Moreover, the openings 12a, 12b have the same diameter. That is, the distance between the opening 12a and the great circle is identical to that between the opening 12b and the great circle. The first case 11 is joined to the second case 12 at the opening 12a. The third case 13 is joined to the second case 12 at the opening 12b. The second case 12 is formed so as to have an inner spherical zone surface. The second case 12 is made of a high hardness material (e.g., a material having hardness higher than that of the first case 11) such as a ceramics material. This can reduce abrasion due to contact with a driver element 42 which will be described later.

The third case 13 is formed in a spherical-sector shape so as not to have the great circle of the outer shell 1. The third case 13 is formed so as to have an inner spherical sector surface. The third case 13 is made of polycarbonate resin.

The inner surfaces of the first case 11, the second case 12, and the third case 13 have the substantially same curvature.

Referring to FIG. 1, the center point (i.e., the center of the second case 12) of the outer shell 1 is defined as an “O point,” a straight line passing through the O point and the centers of the two openings of the second case 12 is defined as a “P axis,” and an axis passing through the O point so as to be perpendicular to the P axis is defined as a “Q axis.”

<3. Camera Body>

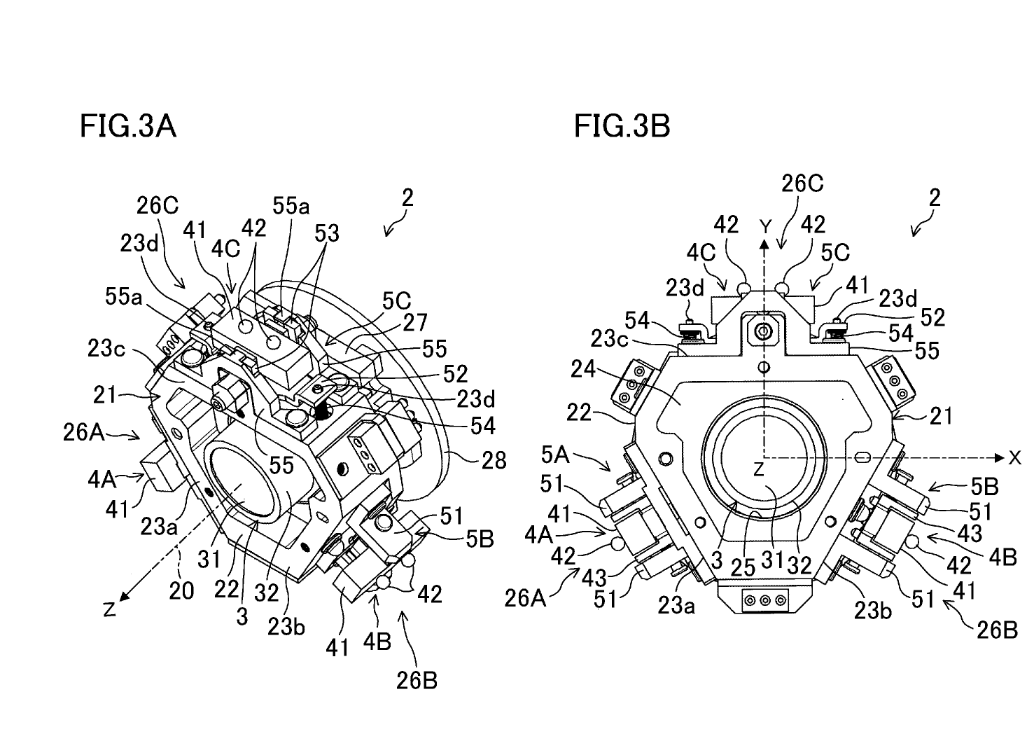

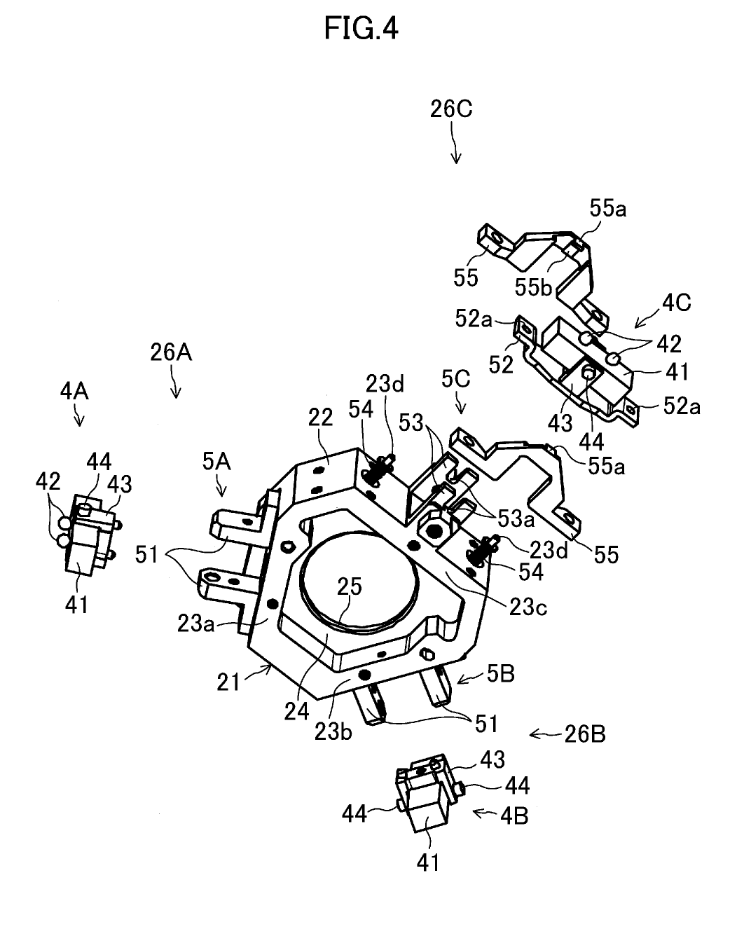

FIGS. 3A and 3B illustrate the camera body 2. FIG. 3A is a perspective view of the camera body 2, and FIG. 3B is a front view of the camera body 2. FIG. 4 is an exploded perspective view of a movable frame 21 and first to third drivers 26A-26C.

The camera body 2 includes the movable frame 21, a lens barrel 3, the first to third drivers 26A-26C attached to the movable frame 21, an attachment plate 27 configured to attach the lens barrel 3 to the movable frame 21, and a circuit board 28 configured to control the camera body 2. The camera body 2 can shoot still images and moving pictures. An optical axis 20 of the lens barrel 3 is referred to as a “Z axis,” and a side close to an object relative to the optical axis 20 is a front side. The camera body 2 is one example of an imager.

The movable frame 21 is a substantially equilateral-triangular frame body as viewed from the front. The movable frame 21 includes an outer peripheral wall 22 which has first to third side walls 23a-23c forming three sides of the triangle, and a dividing wall 24 formed inside the outer peripheral wall 22. An opening 25 is formed at the center of the dividing wall 24.

The lens barrel 3 includes a plurality of lenses 31 having the optical axis 20, a lens frame 32 configured to hold the lenses 31, and an imaging device 33. The lens frame 32 is arranged inside the movable frame 21, and the optical axis 20 passes through the center of the movable frame 21. The attachment plate 27 is provided on a back side of the imaging device 33 of the lens barrel 3 (see FIG. 2B). The lens barrel 3 is attached to the movable frame 21 through the attachment plate 27. The circuit board 28 is attached to the attachment plate 27 on a side opposite to the lens barrel 3.

The first to third drivers 26A-26C are provided on an outer peripheral surface of the movable frame 21. Specifically, the first driver 26A is provided on the first side wall 23a. The second driver 26B is provided on the second side wall 23b. The third driver 26C is provided on the third side wall 23c. The first to third drivers 26A-26C are arranged about the Z axis at substantially equal intervals, i.e., at about every 120°. Referring to FIG. 3B, an axis passing through the third driver 26C so as to be perpendicular to the Z axis is referred to as a “Y axis,” and an axis perpendicular to both of the Z and Y axes is referred to as an “X axis.”

The first driver 26A includes an actuator body 4A and a first support mechanism 5A. The second driver 26B includes an actuator body 4B and a second support mechanism 5B. The third driver 26C includes an actuator body 4C and a third support mechanism 5C.

The actuator bodies 4A-4C have the same configuration. Only the actuator body 4A will be described below, and the description of the actuator bodies 4B, 4C will not be repeated. The actuator body 4A includes an oscillator 41, two driver elements 42 attached to the oscillator 41, and a holder 43 configured to hold the oscillator 41.

The oscillator 41 is a piezoelectric device made of multilayer ceramic. The oscillator 41 is formed in a substantially rectangular parallelepiped shape. In such a manner that predetermined drive voltage (alternating voltage) is applied to an electrode (not shown in the figure) of the oscillator 41, the oscillator 41 harmonically generates stretching vibration in a longitudinal direction of the oscillator 41 and bending vibration in a transverse direction of the oscillator 41.

The driver elements 42 are, on one side surface of the oscillator 41, arranged in the longitudinal direction of the oscillator 41. The driver element 42 is a ceramic spherical body, and is bonded to the oscillator 41. The stretching vibration and the bending vibration of the oscillator 41 generates elliptic motion of each of the driver elements 42. By the elliptic motion of the driver elements 42, drive force in the longitudinal direction of the oscillator 41 is output.

The holder 43 is made of polycarbonate resin containing glass. The holder 43 sandwiches the oscillator 41 from both sides in a layer stacking direction (i.e., a direction perpendicular to both of the longitudinal and transverse directions) of the oscillator 41. The holder 43 is bonded to the oscillator 41. In the holder 43, a rotary shaft 44 extending in the layer stacking direction of the oscillator 41 is provided so as to outwardly protrude.

The first support mechanism 5A includes two brackets 51. The brackets 51 are screwed to an outer surface of the first side wall 23a. The brackets 51 rotatably support the rotary shaft 44 of the holder 43 with the actuator body 4A being sandwiched between the brackets 51. Thus, the actuator body 4A is supported by the first support mechanism 5A so as to rotate about an axis which is parallel to a plane perpendicular to the Z axis and which is parallel to the first side wall 23a. In such a state, the driver elements 42 of the actuator body 4A are arranged parallel to the Z axis.

The second support mechanism 5B has a configuration similar to that of the first support mechanism 5A, and includes two brackets 51. The brackets 51 are screwed to an outer surface of the second side wall 23b. The brackets 51 rotatably support the rotary shaft 44 of the holder 43 with the actuator body 4B being sandwiched between the brackets 51. Thus, the actuator body 4B is supported by the second support mechanism 5B so as to rotate about the axis which is parallel to the plane perpendicular to the Z axis and which is parallel to the second side wall 23b. In such a state, the driver elements 42 of the actuator body 4B are arranged parallel to the Z axis.

The third support mechanism 5C includes a holding plate 52 attached to the holder 43, two supports 53 configured to support the rotary shaft 44 of the actuator body 4C, two biasing springs 54, and stoppers 55 configured to restrict movement of the rotary shaft 44. The holding plate 52 is screwed to the holder 43. The holding plate 52 is a plate-shaped member extending in the longitudinal direction of the oscillator 41, and an opening 52a is formed in each end part of the holding plate 52. A tip end of a pin 23d which will be described later is inserted into the opening 52a. The supports 53 are arranged parallel to a Z-axis direction on the third side wall 23c. A guide groove 53a engaged with the rotary shaft 44 is formed at a tip end of the support 53. The guide groove 53a extends in a direction perpendicular to the Z axis. The rotary shaft 44 of the holder 43 is fitted into the guide grooves 53a so as to move back and forth in a longitudinal direction of the guide groove 53a and to rotate about an axis of the rotary shaft 44. Each tip end of the rotary shaft 44 protrudes beyond the support 53 in the Z-axis direction. Two pins 23d are provided on an outer surface of the third side wall 23c. The biasing spring 54 is fitted onto the pin 23d. The stopper 55 includes a first restrictor 55a configured to restrict movement of the rotary shaft 44 in the longitudinal direction (i.e., a direction in which the guide groove 53a extends) of the guide groove 53a, and a second restrictor 55b configured to restrict movement of the rotary shaft 44 in a direction parallel to the Z axis. The stoppers 55 are screwed to the third side wall 23c. In the state in which the stoppers 55 are attached to the third side wall 23c, each of the first restrictors 55a is fitted into a tip end of the guide groove 53a (see FIG. 3A). In the state in which the stoppers 55 are attached to the third side wall 23c, each of the second restrictors 55b is arranged at a position facing the tip end of the rotary shaft 44 engaged with the guide grooves 53a.

In the third support mechanism 5C configured as described above, the actuator body 4C is mounted in the supports 53 such that the rotary shaft 44 of the holder 43 is fitted into the guide grooves 53a. The holding plate 52 and the third side wall 23c sandwich the biasing springs 54, thereby compressing and deforming the biasing springs 54. In such a state, the stoppers 55 are screwed to the third side wall 23c. The actuator body 4C is, by elastic force of the biasing springs 54, biased toward a side apart from the Z axis in the direction perpendicular to the Z axis. Since each of the tip ends of the guide grooves 53a is closed by the first restrictor 55a of the stopper 55, the rotary shaft 44 is prevented from being detached from the guide grooves 53a. Moreover, since each of the second restrictors 55b of the stoppers 55 is arranged at the position facing the tip end of the rotary shaft 44, movement of the actuator body 4C in the Z-axis direction is restricted by the second restrictors 55b. That is, the actuator body 4C is supported by the third support mechanism 5C so as to move in the longitudinal direction of the guide groove 53a and to rotate about the rotary shaft 44.

FIG. 5 is a functional block diagram of the imaging apparatus 100. The circuit board 28 includes an image processor 61 configured to perform video signal processing based on an output signal from the imaging device 33, a drive controller 62 configured to control driving of the first to third drivers 26A-26C, an antenna 63 configured to transmit/receive a wireless signal, a transmitter 64 configured to convert a signal from the image processor 61 into a transmission signal to transmit the transmission signal through the antenna 63, a receiver 65 configured to receive a wireless signal through the antenna 63 and to convert the wireless signal to output the converted signal to the drive controller 62, a battery 66, and a gyro sensor 67 configured to detect the angular velocity of the camera body 2.

The gyro sensor 67 is for three detection axes. That is, the gyro sensor 67 is a sensor package including an X-axis gyro sensor configured to detect a rotation angular velocity about the X axis, a Y-axis gyro sensor configured to detect a rotation angular velocity about the Y axis, and a Z-axis gyro sensor configured to detect a rotation angular velocity about the Z axis. The gyro sensor 67 is configured to output a signal corresponding to an angular velocity about each of the detection axes. Rotational movement of the camera body 2 can be detected based on an output signal of the gyro sensor 67.

The image processor 61 is configured to perform, e.g., amplification and A/D conversion of an output signal of the imaging device 33. The drive controller 62 is configured to output drive voltage (i.e., a control signal) to each of the first to third drivers 26A-26C. The drive controller 62 generates drive voltage based on a signal (command) input from the outside through the antenna 63 and the receiver 65 and an output signal of the gyro sensor 67.

<4. Configuration of Cleaner>

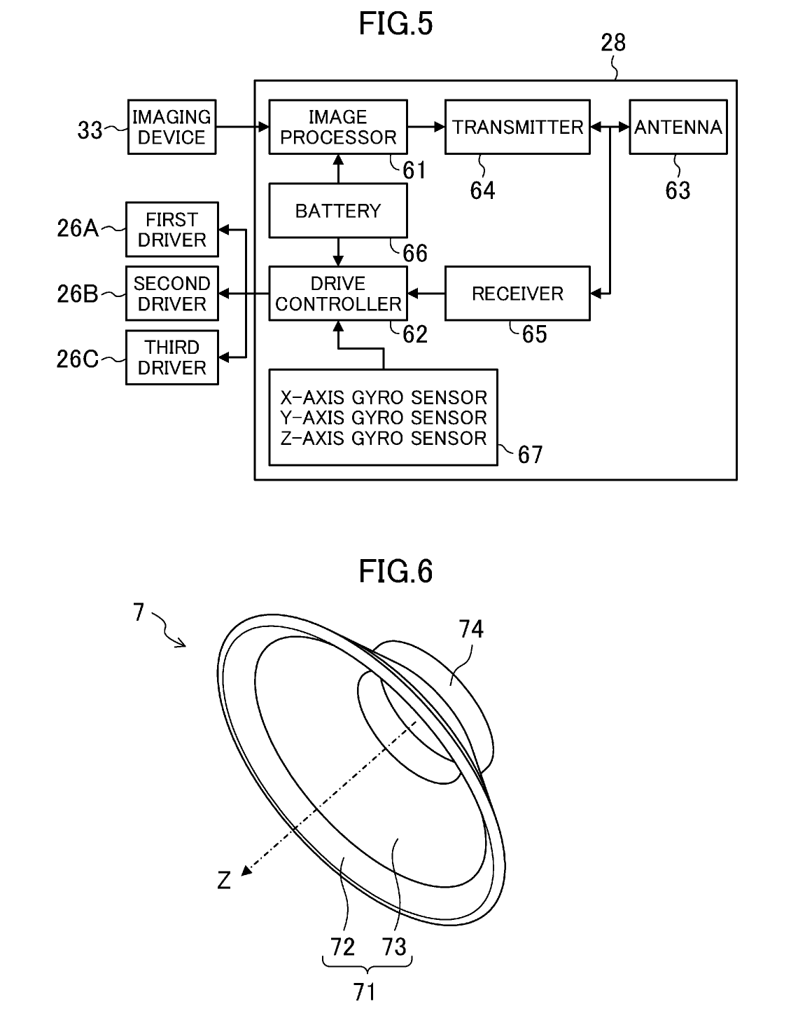

FIG. 6 is a perspective view of the cleaner.

The entirety of the cleaner 7 is in a funnel shape. The cleaner 7 includes a conical base 71 and a cylindrical part 74. The cylindrical part 74 is connected to a smallest-diameter end part of the conical base 71. The cylindrical part 74 is fitted onto the lens frame 32.

The conical base 71 includes a remover 72 provided in a largest-diameter end part of the conical base 71, and a holder 73 connected to the cylindrical part 74. The remover 72 and the holder 73 are connected together. The remover 72 is made of a porous material. Moreover, the remover 72 is made of a material softer than the outer shell 1.

<5. Arrangement of Camera Body inside Outer Shell>

Referring to FIGS. 2A and 2B, the camera body 2 is arranged inside the case 12 of the outer shell 1. The state in which the Z axis of the camera body 2 and the P axis of the outer shell 1 are coincident with each other is referred to as a “reference state.” That is, FIGS. 2A and 2B illustrate the reference state of the imaging apparatus 100. Each of the driver elements 42 of the first to third drivers 26A-26C contacts the inner surface of the second case 12. The lens barrel 3 faces the first case 11, and the camera body 2 shoots an image of an object outside the case 12 through the opening 12a. The circuit board 28 is positioned inside the third case 13 in the reference state. The third driver 26C is movable in a radial direction about the Z axis, and is biased toward the outside in the radial direction by the biasing springs 54. Thus, the driver elements 42 of the third driver 26C contact the inner surface of the second case 12 in the state in which the driver elements 42 are pressed against the inner surface of the second case 12 by elastic force of the biasing springs 54. The driver elements 42 of the first and second drivers 26A, 26B contact the inner surface of the second case 12 in the state in which the driver elements 42 are pressed against the inner surface of the second case 12 by reactive force of the biasing springs 54. In the reference state, the driver elements 42 of the first driver 26A are arranged parallel to the P axis. The driver elements 42 of the second driver 26B are arranged parallel to the P axis. On the other hand, the driver elements 42 of the third driver 26C are arranged in a circumferential direction of the great circle of the outer shell 1, i.e., in a circumferential direction about the P axis. The actuator body 4C of the third driver 26C is movable in the radial direction about the Z axis, and each of the actuator bodies 4A-4C of the first to third drivers 26A-26C is supported so as to rotate about the rotary shaft 44. Thus, e.g., a shape error of the inner surface of the second case 12 and an assembly error of each of the drivers are absorbed.

The remover 72 of the cleaner 7 attached to the lens frame 32 contacts the inner surface of the outer shell 1. Moreover, the conical base 71 of the cleaner 7 is positioned outside a shooting range S of the lens barrel 3 defined by the angle of view of the lens barrel 3.

<6. Operation of Camera Body>

When drive voltage is applied to the first to third drivers 26A-26C, elliptic motion of each of the driver elements 42 of the first to third drivers 26A-26C is generated. Upon the elliptic motion of the driver elements 42, the first driver 26A outputs drive force in the direction parallel to the Z axis. The second driver 26B outputs drive force in the direction parallel to the Z axis. The third driver 26C outputs drive force in a circumferential direction about the Z axis. Thus, the drive force of the first driver 26A and the drive force of the second driver 26B can be combined together, thereby arbitrarily adjusting the inclination of the Z axis of the camera body 2 relative to the P axis of the outer shell 1. Moreover, the camera body 2 can rotate about the Z axis by the drive force of the third driver 26C. As in the foregoing, in such a manner that the drive force of the first to third drivers 26A-26C is adjusted, the camera body 2 can rotate/move relative to the outer shell 1, and the attitude of the camera body 2 on the outer shell 1 can be arbitrarily adjusted.

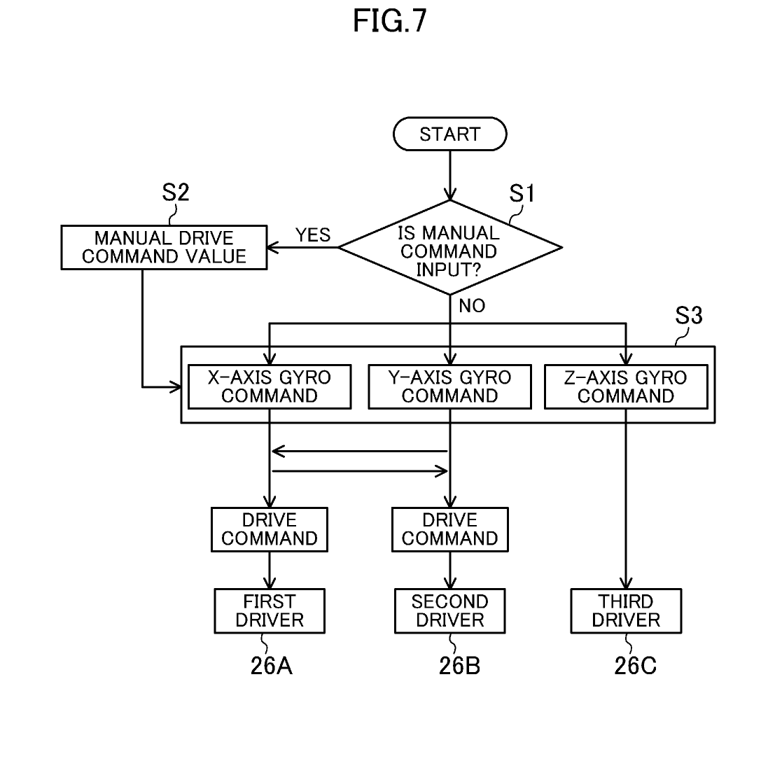

FIG. 7 is a flowchart of a drive control.

First, the drive controller 62 determines, at step S1, whether or not a manual command is input from the outside through wireless communication. The manual command is, e.g., a command to follow a particular object or a command to perform panning (i.e., rotation about the Y axis), tilting (i.e., rotation about the X axis), or rolling (i.e., rotation about the Z axis) of the camera body 2 at a predetermined angle. If the manual command is input, the drive controller 62 proceeds to step S2. On the other hand, if no manual command is input, the drive controller 62 proceeds to step S3.

At step S2, the drive controller 62 generates a manual drive command value based on the manual command. The manual drive command value is a command value for each of the first to third drivers 26A-26C. Subsequently, the process proceeds to step S3.

At step S3, the drive controller 62 generates, based on an output of the gyro sensor 67, a command value for canceling rotation of the camera body 2 due to disturbance. Specifically, the drive controller 62 generates, based on a detection signal of the gyro sensor 67, a command value (hereinafter referred to as an “X-axis gyro command value”) for rotation about the X axis, a command value (hereinafter referred to as a “Y-axis gyro command value”) for rotation about the Y axis, and a command value (hereinafter referred to as a “Z-axis gyro command value”) for rotation about the Z axis such that rotation of the camera body 2 about the X, Y, and Z axes is canceled. The X-axis gyro command value and the Y-axis gyro command value are synthesized at a predetermined rate, thereby generating a drive command value to be output to the first driver 26A. Moreover, the X-axis gyro command value and the Y-axis gyro command value are synthesized at a predetermined rate, thereby generating a drive command value to be output to the second driver 26B. The Z-axis gyro command value is output to the third driver 26C as a drive command value. If the manual drive command value is generated, a final drive command value is generated by adding the manual drive command value to a drive command value obtained based on the gyro command value. The drive controller 62 applies drive voltage corresponding to the generated drive command value to each of the first to third drivers 26A-26C.

As a result, if no manual command is input, the first to third drivers 26A-26C are operated such that disturbance acting on the camera body 2 is canceled, and therefore the attitude of the camera body 2, i.e., the direction of the optical axis 20, is maintained constant. On the other hand, if the manual command is input, the first to third drivers 26A-26C are operated such that disturbance acting on the camera body 2 is canceled and that the camera body 2 moves according to the manual command.

Since shaking of the camera body 2 upon rotation thereof is, regardless of presence/absence of the manual command, reduced based on an output of the gyro sensor 67, blurring of a shot image is reduced. Moreover, the image processor 61 detects a motion vector of a moving picture and performs, by image processing, electronic correction of an image blur based on the motion vector. That is, in the imaging apparatus 100, a relatively-large image blur with a low frequency is reduced by controlling the attitude of the camera body 2, and a relatively-small image blur with a high frequency is corrected by electronic correction of the image processor 61.

<7. Cleaning Inside Outer Shell>

In the imaging apparatus 100 configured as described above, the first to third drivers 26A-26C contact the inner surface of the outer shell 1, and therefore abrasion powder may be generated inside the outer shell 1.

Referring to FIG. 2B, the cleaner 7 moves together with the camera body 2, and the remover 72 slidably contacts the inner surface of the outer shell 1. Thus, the remover 72 can sweep and remove a foreign substance(s) on the inner surface of the outer shell 1. Moreover, since the remover 72 is made of the porous material, the foreign substance(s) adheres to the remover 72 after sweeping. As in the foregoing, the remover 72 wipes, in association with movement of the camera body 2, off a foreign substance(s) on the inner surface of the outer shell 1.

The cleaner 7 is, as described above, attached to the lens barrel 3, and contacts the inner surface of the outer shell 1. Thus, a space inside the outer shell 1 is divided into two spaces. The shooting range S of the lens barrel 3 is in a first space M which is one of the spaces divided by the cleaner 7, and the first to third drivers 26A-26C are in a second space N which is the other space. Abrasion powder is generated in the second space N. That is, the cleaner 7 has a function to separate the space with the shooting range S of the lens barrel 3 from the space where abrasion powder is generated. Thus, even if a foreign substance(s) swept by the remover 72 does not adhere to the remover 72, such a foreign substance(s) is accumulated in the second space N.

A foreign substance(s) inside the outer shell 1 adheres to the remover 72 or is swept and collected in the second space N. Since the cleaner 7 moves together with the camera body 2, the first and second spaces M, N also move together with the camera body 2. Thus, a foreign substance(s) adhering to the remover 72 or accumulated in the second space N does not enter the first space M.

<8. Usage Example of Imaging Apparatus>

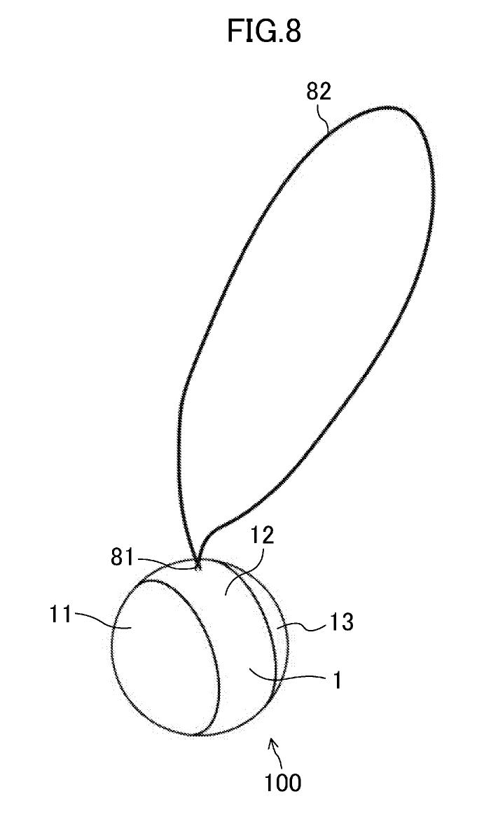

FIG. 8 illustrates a usage example of the imaging apparatus 100.

A pin 81 is provided on an outer surface of the second case 12. A strap 82 is attached to the pin 81. A hook-and-loop fastener (not shown in the figure) is provided on an outer surface of the third case 13.

A user wears the strap 82 around a neck, and uses the imaging apparatus 100 with the imaging apparatus 100 being hung from the neck. In such a state, the hook-and-loop fastener is attached to, e.g., clothes, thereby reducing or preventing large shaking of the imaging apparatus 100 during walking etc.

The camera body 2 can be operated in panning, tilting, and rolling directions by a wireless communication device such as a smart phone. Moreover, image blurring during walking can be reduced by the gyro sensor 67.

<9. Advantages>

Thus, the imaging apparatus 100 includes the outer shell 1 having the spherical inner surface, the camera body 2 configured to be movable inside the outer shell 1 and to shoot an image of an object outside the outer shell 1 through the outer shell 1, the first to third drivers 26A-26C attached to the camera body 2 and configured to drive the camera body 2 with the first to third drivers 26A-26C contacting the inner surface of the outer shell 1, and the cleaner 7 configured to clean up a foreign substance(s) on the inner surface of the outer shell 1.

According to such a configuration, since the first to third drivers 26A-26C contact the inner surface of the outer shell 1, abrasion powder is generated inside the outer shell 1. Thus, even if there is a foreign substance(s) inside the outer shell 1, the foreign substance(s) inside the outer shell 1 can be cleaned up by the cleaner 7. This reduces the foreign substance(s) inside the outer shell 1, and therefore unexpected appearance of the foreign substance(s) in a shot image of the camera body 2 is reduced or prevented. As a result, degradation of an image quality due to the foreign substance(s) can be reduced.

The cleaner is configured to sweep off a foreign substance(s) on the inner surface of the outer shell 1.

Thus, the foreign substance(s) on the inner surface of the outer shell 1 can be easily removed.

Moreover, the cleaner is configured to wipe off a foreign substance(s) on the inner surface of the case. Specifically, the cleaner 7 slidably contacts the inner surface of the outer shell 1, and part of the cleaner 7 slidably contacting the outer shell 1 is made of the porous material. That is, the cleaner 7 can not only sweep off but also wipe off a foreign substance(s) by adsorption of the porous material.

According to such a configuration, a foreign substance(s) collected by the cleaner 7 can be prevented from spreading again.

The cleaner 7 is configured to move together with the camera body 2 in the state in which the cleaner 7 is positioned outside the shooting range S of the camera body 2.

According to such a configuration, the cleaner 7 is positioned outside the shooting range S of the camera body 2. The cleaner 7 moves together with the camera body 2, with the foregoing state being maintained. That is, even if the camera body 2 moves, the cleaner 7 does not enter the shooting range S of the camera body 2.

Since the cleaner 7 is attached to the camera body 2, the cleaner 7 automatically cleans the inside of the outer shell 1 while the camera body 2 moves. That is, it is not necessary to provide an additional mechanism configured to drive the cleaner 7.

### Second Embodiment

Subsequently, an imaging apparatus 200 of a second embodiment will be described. In the imaging apparatus 200, a configuration of a camera body 202 is different from that of the camera body 2 of the first embodiment. Thus, the same reference numerals as those shown in the first embodiment are used to represent equivalent elements of the imaging apparatus 200, and the description thereof will not be repeated. Differences will be mainly described.

<1. Schematic Configuration>

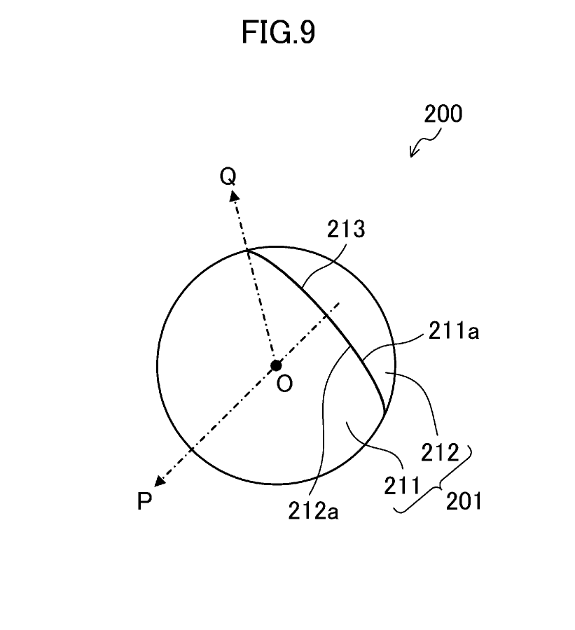

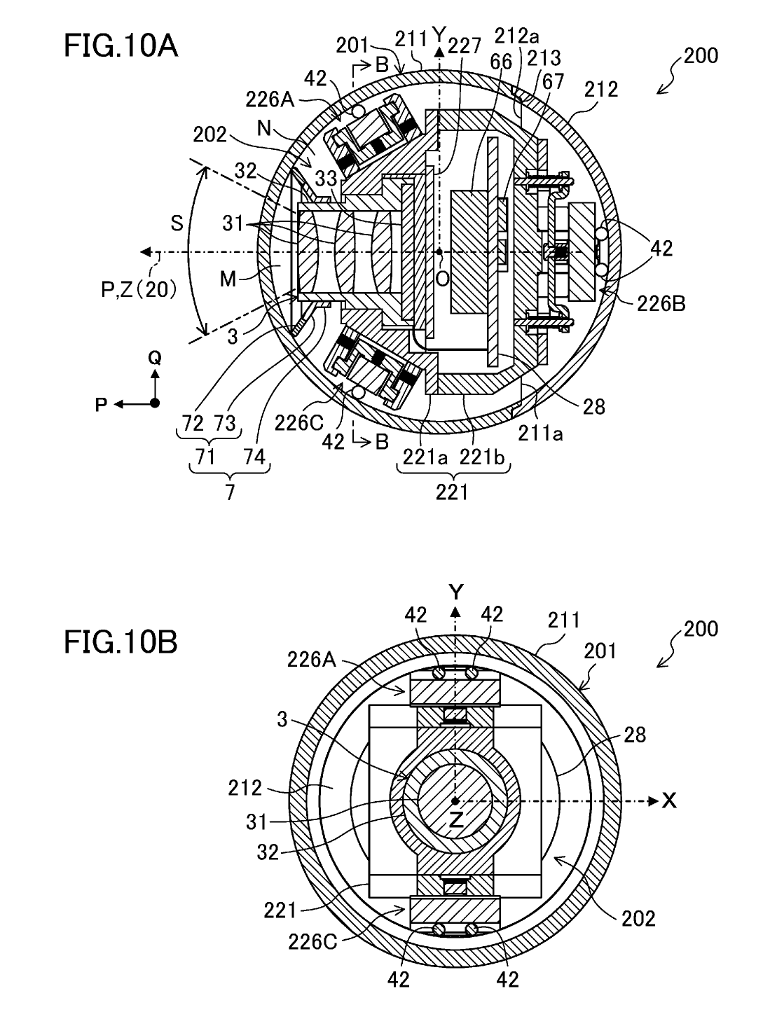

FIG. 9 is a perspective view of the imaging apparatus 200. FIGS. 10A and 10B are cross-sectional views of the imaging apparatus 200. FIG. 10A is the cross-sectional view of the imaging apparatus 200 along a plane passing through the center O of an outer shell 201 and including a P axis, and FIG. 10B is the cross-sectional view of the imaging apparatus 200 along a B-B line illustrated in FIG. 10A.

The imaging apparatus 200 includes the substantially spherical outer shell 201, the camera body 202 arranged inside the outer shell 201, and a cleaner 7 configured to clean up a foreign substance(s) inside the outer shell 201. The camera body 202 moves relative to the outer shell 201 along an inner surface of the outer shell 201. While moving inside the outer shell 201, the camera body 202 shoots, through the outer shell 201, an image of an object outside the outer shell 201.

<2. Outer Shell>

The outer shell 201 includes a first case 211 and a second case 212. The first case 211 and the second case 212 are joined together, thereby forming a substantially spherical shape. The outer shell 201 has a substantially spherical inner surface. The outer shell 201 is an example of a case.

The first case 211 is formed in a spherical-sector shape so as to have the great circle of the outer shell 201. The first case 211 is formed with an opening 211a, and is formed so as to have an inner spherical zone surface. The inner surface of the first case 211 has the substantially same curvature as that of an inner surface of the second case 212. The first case 211 is made of a high hardness material (e.g., a ceramics material) transparent to visible light. The high hardness material allows reduction in abrasion due to contact with a driver element 42 which will be described later. The light transmittance of the first case 211 is higher than that of the second case 212.

The second case 212 is formed in a spherical-sector shape so as not to have the great circle of the outer shell 201. The second case 212 is formed with an opening 212a, and is formed so as to have an inner spherical zone surface. The opening 212a has the same diameter as that of the opening 211a. The second case 212 is made of a high hardness material (e.g., a ceramics material). Thus, abrasion due to contact with the later-described driver element 42 can be reduced.

The first and second cases 211, 212 are joined together at the openings 211a, 212a. Thus, the outer shell 201 includes a joint part 213.

Referring to FIG. 9, the center point (i.e., the center of the first case 211) of the outer shell 201 is defined as an “O point,” a straight line passing through the O point and the center of the opening 211a of the first case 211 is defined as a “P axis,” and an axis passing through the O point so as to be perpendicular to the P axis is defined as a “Q axis.”

<3. Camera Body>

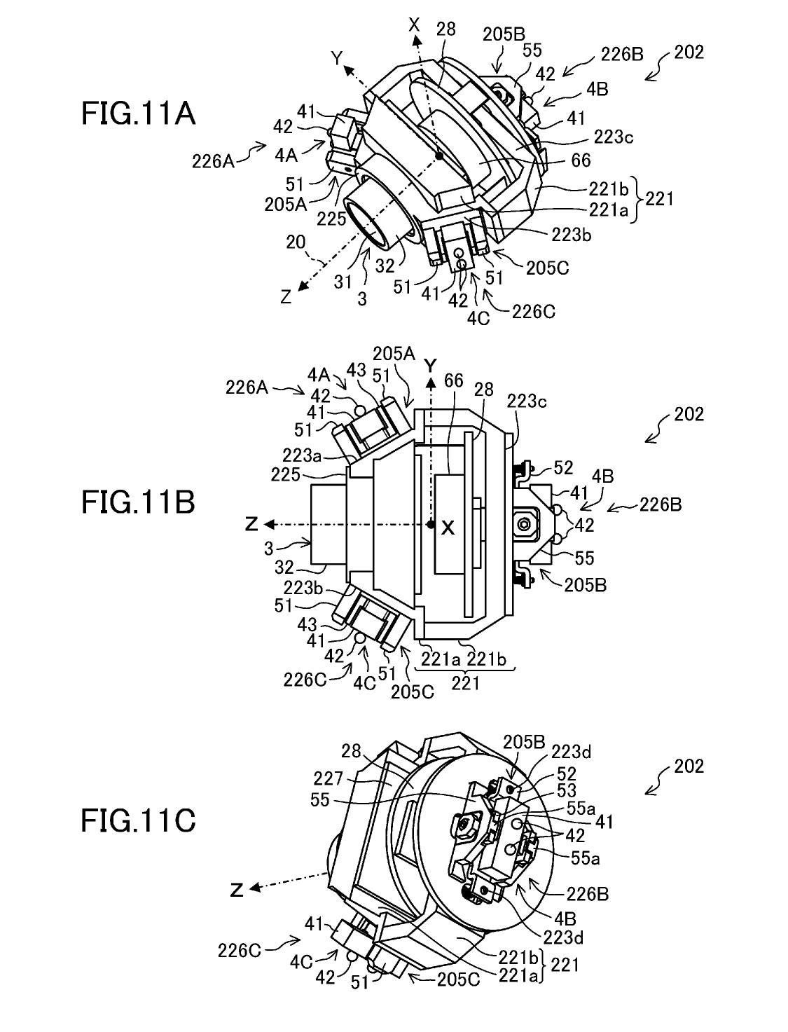

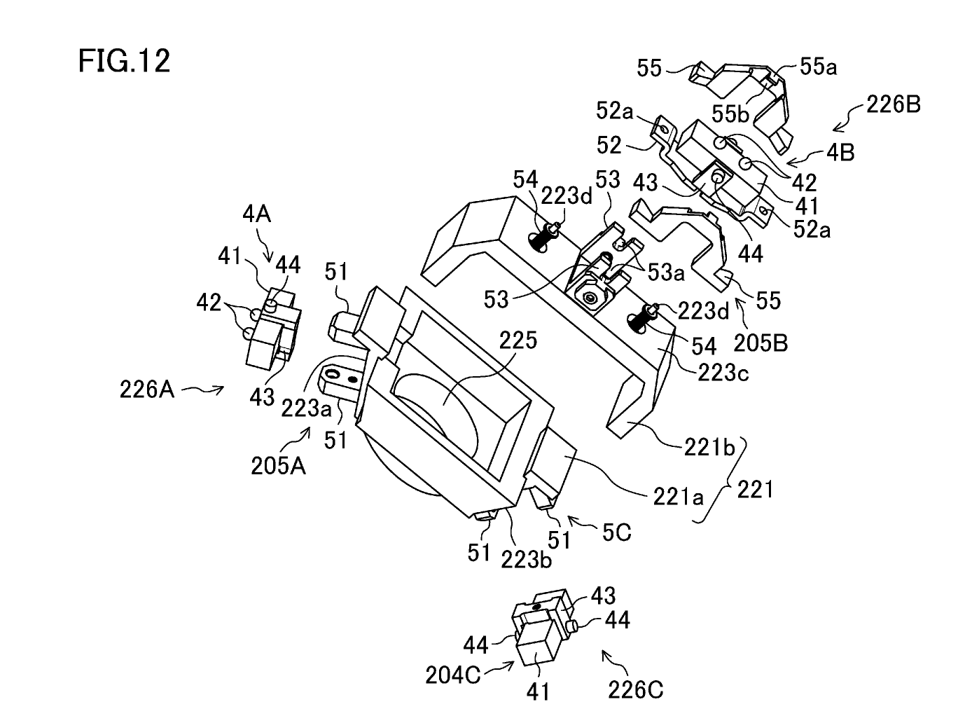

FIGS. 11A, 11B, and 11C illustrate the camera body 202. FIG. 11A is a perspective view of the camera body 202, FIG. 11B is a right side view of the camera body 202, and FIG. 11C is a perspective view of the camera body 202 from an angle different from that of FIG. 11A. FIG. 12 is an exploded perspective view of a movable frame 221 and first to third drivers 226A-226C.

The camera body 202 includes the movable frame 221, a lens barrel 3, the first to third drivers 226A-226C attached to the movable frame 221, an attachment plate 227 configured to attach the lens barrel 3 to the movable frame 221, and a circuit board 28 configured to control the camera body 202. The camera body 202 can shoot still images and moving pictures. An optical axis 20 of the lens barrel 3 is referred to as a “Z axis,” and a side close to an object relative to the optical axis 20 is a front side. The camera body 202 is one example of an imager.

The movable frame 221 includes a first frame 221a and a second frame 221b. The first frame 221a and the second frame 221b are fixed together with screws. The first frame 221a includes a first side wall 223a to which the first driver 226A is attached, a second side wall 223b to which the third driver 226C is attached, and a cylindrical part 225 in which the lens barrel 3 is arranged. An axis of the cylindrical part 225 is coincident with the Z axis. The first side wall 223a and the second side wall 223b are parallel to an X axis perpendicular to the Z axis, and are inclined to the Z axis. Specifically, the Z axis is a bisector of an angle between the normal of an outer surface of the first side wall 223a and the normal of an outer surface of the second side wall 223b. The second frame 221b includes a third side wall 223c to which the second driver 226B is attached. The third side wall 223c is perpendicular to the Z axis.

Note that an axis perpendicular to both of the Z and X axes is referred to as a “Y axis.”

The lens barrel 3 has the same configuration as that of the first embodiment. A lens frame 32 is arranged in the cylindrical part 225 of the movable frame 221, and the optical axis 20 is coincident with the axis of the cylindrical part 225. The attachment plate 227 is provided on a rear side of an imaging device 33 of the lens barrel 3 (see FIG. 10A). The lens barrel 3 is attached to the movable frame 221 through the attachment plate 227.

The cleaner 7 is attached to the lens frame 32. A configuration of the cleaner 7 is the same as that of the first embodiment.

The first to third drivers 226A-226C are provided on an outer peripheral surface of the movable frame 221. Specifically, the first driver 226A is provided on the first side wall 223a. The second driver 226B is provided on the third side wall 223c. The third driver 226C is provided on the second side wall 223b. The first to third drivers 226A-226C are arranged about the X axis at substantially equal intervals, i.e., at about every 120°.

The first driver 226A includes an actuator body 4A and a first support mechanism 205A. The second driver 226B includes an actuator body 4B and a second support mechanism 205B. The third driver 226C includes an actuator body 4C and a third support mechanism 205C.

The actuator bodies 4A-4C have the same configuration. The actuator bodies 4A-4C have the same configuration as that of the first embodiment.

A basic configuration of the first support mechanism 205A is the same as that of the first support mechanism 5A of the first embodiment. The first support mechanism 205A and the first support mechanism 5A are different from each other in the attitude of the actuator body 4A. Specifically, the actuator body 4A is supported by the first support mechanism 205A so as to rotate about an axis contained in a plane including the Y and Z axes and inclined to the Z axis. In such a state, two driver elements 42 of the actuator body 4A are arranged parallel to the X axis.

A basic configuration of the third support mechanism 205C is the same as that of the second support mechanism 5B of the first embodiment. The third support mechanism 205C and the second support mechanism 5B are different from each other in the attitude of the actuator body 4C (actuator body 4B). Specifically, the actuator body 4C is supported by the third support mechanism 205C so as to rotate about the axis contained in the plane including the Y and Z axes and inclined to the Z axis. In such a state, two driver elements 42 of the actuator body 4C are arranged parallel to the X axis.

A basic configuration of the second support mechanism 205B is the same as that of the third support mechanism 5C of the first embodiment. The second support mechanism 205B and the third support mechanism 5C are different from each other in the attitude of the actuator body 4B (actuator body 4C). Specifically, the actuator body 4B is supported by the second support mechanism 205B so as to move in a longitudinal direction (Z-axis direction) of a guide groove 53a and to rotate about a rotary shaft 44. In such a state, two driver elements 42 of the actuator body 4B are arranged parallel to the Y axis.

<4. Arrangement of Camera Body inside Outer Shell>

Referring to FIGS. 10A and 10B, the camera body 202 is arranged inside the outer shell 201. The state in which the Z axis of the camera body 202 and the P axis of the outer shell 201 are coincident with each other is referred to as a “reference state.” That is, FIGS. 10A and 10B illustrate the reference state of the imaging apparatus 200. Each of the driver elements 42 of the first and third drivers 226A, 226C contacts the inner surface of the first case 211. The driver elements 42 of the second driver 226B contact the inner surface of the second case 212. The lens barrel 3 faces the first case 211, and the camera body 202 shoots an image of an object through the first case 211. The second driver 226B is movable in a radial direction about the X axis (i.e., in the Z-axis direction), and is biased toward the outside in the radial direction by biasing springs 54. Thus, the driver elements 42 of the second driver 226B contact the inner surface of the second case 212 in the state in which the driver elements 42 are pressed against the inner surface of the second case 212 by elastic force of the biasing springs 54. The driver elements 42 of the first and third drivers 226A, 226C contact the inner surface of the first case 211 in the state in which the driver elements 42 are pressed against the inner surface of the first case 211 by reactive force of the biasing springs 54. In such a state, the actuator body 4B of the second driver 226B is movable in the Z-axis direction, and each of the actuator bodies 4A-4C of the first to third drivers 226A-226C is supported so as to rotate about the rotary shaft 44 thereof. Thus, e.g., a shape error of the inner surface of the outer shell 201 and an assembly error of each of the drivers are absorbed.

A remover 72 of the cleaner 7 attached to the lens frame 32 contacts the inner surface of the outer shell 201. Moreover, a conical base 71 of the cleaner 7 is positioned outside a shooting range S of the lens barrel 3 defined by the angle of view of the lens barrel 3.

<5. Operation of Camera Body>

When drive voltage is applied to the first to third drivers 226A-226C, elliptic motion of each of the driver elements 42 of the first to third drivers 226A-226C is generated. The driver elements 42 of the first driver 226A are arranged in a circumferential direction about the Z axis. The driver elements 42 of the third driver 226C are arranged in the circumferential direction about the Z axis. On the other hand, the driver elements 42 of the second driver 226B are arranged in a circumferential direction about the X axis. Thus, upon the elliptic motion of the driver elements 42, the first driver 226A outputs drive force in the circumferential direction about the Z axis. The third driver 226C outputs drive force in the circumferential direction about the Z axis. The second driver 226B outputs drive force in the circumferential direction about the X axis. Thus, the drive force of the first driver 226A and the drive force of the third driver 226C can be combined together, thereby rotating the camera body 202 about the Y axis or the Z axis. Moreover, the camera body 202 can rotate about the X axis by the drive force of the second driver 226B. As in the foregoing, in such a manner that the drive force of the first to third drivers 226A-226C is adjusted, the camera body 202 can rotate/move relative to the outer shell 201, and the attitude of the camera body 202 on the outer shell 201 can be arbitrarily adjusted.

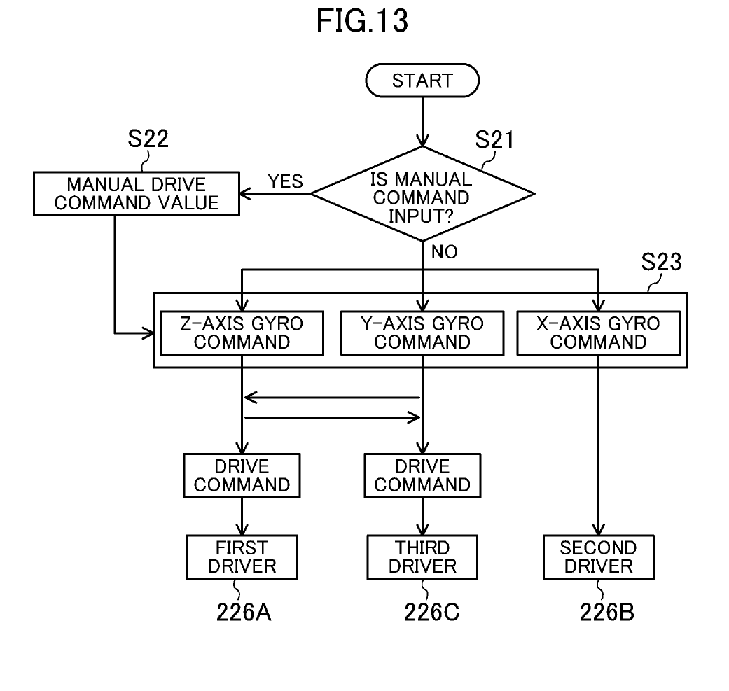

FIG. 13 illustrates a flowchart of a drive control.

First, a drive controller 62 determines, at step S21, whether or not a manual command is input from the outside through wireless communication. The manual command is, e.g., a command to follow a particular object or a command to perform panning (i.e., rotation about the Y axis), tilting (i.e., rotation about the X axis), or rolling (i.e., rotation about the Z axis) of the camera body 202 at a predetermined angle. If the manual command is input, the drive controller 62 proceeds to step S22. On the other hand, if no manual command is input, the drive controller 62 proceeds to step S23.

At step S22, the drive controller 62 generates a manual drive command value based on the manual command. The manual drive command value is a command value for each of the first to third drivers 226A-226C. Subsequently, the process proceeds to step S23.

At step S23, the drive controller 62 generates, based on an output of the gyro sensor 67, a command value for canceling rotation of the camera body 202 due to disturbance. Specifically, the drive controller 62 generates, based on a detection signal of the gyro sensor 67, a command value (hereinafter referred to as an “X-axis gyro command value”) for rotation about the X axis, a command value (hereinafter referred to as a “Y-axis gyro command value”) for rotation about the Y axis, and a command value (hereinafter referred to as a “Z-axis gyro command value”) for rotation about the Z axis such that rotation of the camera body 202 about the X, Y, and Z axes is canceled. The Z-axis gyro command value and the Y-axis gyro command value are synthesized at a predetermined rate, thereby generating a drive command value to be output to the first driver 226A. Moreover, the Z-axis gyro command value and the Y-axis gyro command value are synthesized at a predetermined rate, thereby generating a drive command value to be output to the third driver 226C. The X-axis gyro command value is output to the second driver 226B as a drive command value. If the manual drive command value is generated, a final drive command value is generated by adding the manual drive command value to a drive command value obtained based on the gyro command value. The drive controller 62 applies drive voltage corresponding to the generated drive command value to each of the first to third drivers 226A-226C.

As a result, if no manual command is input, the first to third drivers 226A-226C are operated such that disturbance acting on the camera body 202 is canceled, and therefore the attitude of the camera body 202, i.e., the direction of the optical axis 20, is maintained constant. On the other hand, if the manual command is input, the first to third drivers 226A-226C are operated such that disturbance acting on the camera body 202 is canceled and that the camera body 202 moves according to the manual command.

Since shaking of the camera body 202 upon rotation thereof is, regardless of presence/absence of the manual command, reduced based on an output of the gyro sensor 67, blurring of a shot image is reduced. Moreover, an image processor 61 detects a motion vector of a moving picture and performs, by image processing, electronic correction of an image blur based on the motion vector. That is, in the imaging apparatus 200, a relatively-large image blur with a low frequency is reduced by controlling the attitude of the camera body 202, and a relatively-small image blur with a high frequency is corrected by electronic correction of the image processor 61.

<9. Cleaning Inside Outer Shell>

In the imaging apparatus 200 configured as described above, since the first to third drivers 226A-226C contact the inner surface of the outer shell 201, abrasion powder may be generated inside the outer shell 201. However, a foreign substance(s) inside the outer shell 201 is, as in the first embodiment, wiped off by the cleaner 7. Moreover, the cleaner 7 divides a space inside the outer shell 201 into a first space M with the shooting range S of the lens barrel 3 and a second space N with the first to third drivers 226A-226C. The collected foreign substance(s) is trapped in the second space N.

A foreign substance(s) inside the outer shell 201 adheres to the remover 72 or is swept and collected in the second space N. Thus, the foreign substance(s) does not enter the first space M.

As a result, deterioration of a shot image can be reduced or prevented. Besides the foregoing, features and advantages similar to those of the first embodiment can be realized.

### Other Embodiment

As described above, the foregoing embodiment has been described as example techniques disclosed in the present application. However, the techniques according to the present disclosure are not limited to the foregoing embodiment, but are also applicable to those where modifications, substitutions, additions, and omissions are made. In addition, elements described in the foregoing embodiment may be combined to provide a different embodiment. As such, elements illustrated in the attached drawings or the detailed description may include not only essential elements for solving the problem, but also non-essential elements for solving the problem in order to illustrate such techniques. Thus, the mere fact that those non-essential elements are shown in the attached drawings or the detailed description should not be interpreted as requiring that such elements be essential.

The foregoing embodiments may have the following configurations.

The imaging apparatus 100 shoots still images and moving pictures. However, the imaging apparatus 100 may shoot only still images or moving pictures.

The configurations of the outer shells 1, 201 are not limited to the foregoing embodiments. For example, the outer shell 1, 201 may be divided into more than four parts. Moreover, an outer surface of the outer shell 1, 201 may be in any shapes as long as the inner surface of the outer shell 1, 201 is in a spherical shape. Further, the inner surface of the outer shell 1, 201 is not necessarily in a complete spherical shape, and at least a region contacting the drivers may form a spherical shape.

The first to third drivers 226A-226C are vibration actuators each including a piezoelectric device, but are not limited to such actuators. For example, the driver may include a stepping motor and a drive wheel, and may be configured such that the drive wheel contacts the inner surface of the outer shell 1, 201.

The number and arrangement of the drivers 26A-26C, 226A-226C can be freely set. For example, the number of drivers is not limited to three, and may be equal to or less than two or equal to or greater than four.

The cleaner 7 is not limited to the foregoing configuration. For example, the cleaner 7 may be attached to part other than the lens frame 23, such as the movable frame 21. Moreover, the remover 72 of the cleaner 7 is not necessarily porous. That is, the remover 72 of the cleaner 7 may not have a function to cause a foreign substance(s) to adhere thereto, but a function to sweep off a foreign substance(s). Further, the cleaner 7 does not necessarily move together with the camera body 2, 202. For example, an additional driver configured to drive the cleaner 7 may be provided to separately move the cleaner 7 and the camera body 2, 202.

As described above, the technique disclosed herein is useful for the imaging apparatus including the imager arranged inside the case having the spherical inner surface.

What is claimed is:

1. An imaging apparatus for shooting an image of an object, comprising:
a case having a spherical inner surface;
an imager configured to be movable inside the case and to shoot the image of the object outside the case through the case;
a driver attached to the imager and configured to drive the imager with the driver contacting an inner surface of the case; and
a cleaner configured to clean up a foreign substance on the inner surface of the case.

2. The imaging apparatus of claim 1, wherein
the cleaner is configured to wipe or sweep off the foreign substance on the inner surface of the case.

3. The imaging apparatus of claim 1, wherein
the cleaner is configured to move together with the imager in a state in which the cleaner is positioned outside a shooting range of the imager.
